(19) United States
(12) Patent Application Publication
(10) Pub. No.: US 2018/0118377 A1
(43) Pub. Date: May 3, 2018

(54) SEQUENTIAL RENDEZVOUS OF SPACECRAFT WITH TARGET OBJECTS

(71) Applicant: NXTRAC, Redondo Beach, CA (US)

(72) Inventor: Darren D. Garber, Rancho Palos Verdes, CA (US)

(21) Appl. No.: 15/794,533

(22) Filed: Oct. 26, 2017

Related U.S. Application Data
(60) Provisional application No. 62/496,742, filed on Oct. 28, 2016.

(51) Int. Cl. B64G 1/10; B64G 1/00; G05D 1/02

(52) U.S. Cl. CPC B64G 1/105; B64G 2001/1064; G05D 1/02; B64G 1/007

(57) ABSTRACT

Elements described herein provide enhancements for spacecraft exploration platforms. In one example, a method of space exploration is provided that includes identifying target objects for approach by a spacecraft, and determining nodal crossings of the target objects with regard to a selected orbital plane about a central body. The method also includes positioning a spacecraft into an initial orbit in the selected orbital plane, determining one or more orbital adjustments for the spacecraft that are restricted to the selected orbital plane to sequentially approach the target objects at the nodal crossings, and approaching the target objects using the one or more orbital adjustments to detect at least a characteristic related to each of the target objects.

### RELATED APPLICATIONS

This application hereby claims the benefit of and priority to U.S. Provisional Patent Application 62/496,742, titled “A METHOD FOR SPACECRAFT TO RENDEZVOUS WITH NEAR EARTH OBJECTS,” filed Oct. 28, 2016, which is hereby incorporated by reference in its entirety.

### BACKGROUND

Spacecraft can be launched into Earth orbit and beyond to provide various tasks, such as communications, exploration, science payload deployment, imaging, analysis, or other tasks. Some of these spacecraft comprise satellites which remain in Earth orbit or other planetary orbits to perform various specialized roles. Typically, satellites can be commanded to change orbits or attitudes using on-board thruster, engines, gyroscopic elements, among other elements to reach desired orbits or orientations. However, when large adjustments are required to perform a task or reach a particular spatial region, limitations can arise. For example, a limited amount of propellant or power might be available to perform these changes which can limit the quantity of adjustments or the magnitude of adjustments.

Exploration of objects in and beyond Earth orbit has become desirable for measuring the physical characteristics of such objects, which may include asteroids, comets, or even debris from other satellites and spacecraft. Some Near-Earth Object (NEO) explorations missions include the NEAR Shoemaker, Hayabusa and ROSETTA missions. In general, these missions have involved maneuvering of the spacecraft in three dimensions in order to make the desired contact with the targets. Specifically, each spacecraft had to maneuver in three dimensions match the three-dimensional trajectories of the specific target of the mission, which typically includes preplanned three-dimensional maneuvers to arrive in close proximity for the measurement of the physical characteristics of the targets. The maneuvering of spacecraft in three dimensions uses a considerable amount of stored energy to provide for rendezvous with a preselected target in a predetermined flight plan of the spacecraft. Thus, since 1985 only about 21 NEOs (13 asteroids and 8 comets) have been surveyed by 15 spacecraft missions due to the large energy required to change the orbital flight path of the spacecraft to rendezvous with the specific targets.

### Overview

Elements described herein provide enhancements for spacecraft exploration platforms. In one example, a method of space exploration is provided that includes identifying target objects for approach by a spacecraft, and determining nodal crossings of the target objects with regard to a selected orbital plane about a central body. The method also includes positioning a spacecraft into an initial orbit in the selected orbital plane, determining one or more orbital adjustments for the spacecraft that are restricted to the selected orbital plane to sequentially approach the target objects at the nodal crossings, and approaching the target objects using the one or more orbital adjustments to detect at least a characteristic related to each of the target objects.

This Overview is provided to introduce a selection of concepts in a simplified form that are further described below in the Technical Disclosure. It should be understood that this Overview is not intended to identify key features or essential features of the claimed subject matter, nor should it be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a space exploration environment according to an implementation.

FIG. 2 illustrates a method of space exploration according to an implementation.

FIG. 3 illustrates an expanded view of a spacecraft capable of providing a platform for space exploration according to an implementation.

FIG. 4 illustrates a space exploration environment according to an implementation.

FIG. 5 illustrates a plurality of example NEOs crossing an ecliptic plane in a descending node.

FIG. 6 illustrates a plurality of example NEOs crossing an ecliptic plane in a descending node.

FIG. 7 illustrates an example exploration survey of example of NEOs.

### DETAILED DESCRIPTION

Discussed herein are various enhanced techniques and systems for spacecraft to approach or rendezvous with a plurality of space objects such as near-earth objects (NEO), debris, other satellites, or any target body in the solar system. These enhancements avoid three-dimensional maneuvers of a spacecraft which require an expenditure of considerable energy to achieve a change in velocity (delta V) required for the three-dimensional maneuvering. The delta V is related to the energy expended by the spacecraft, which typically must be carried by the spacecraft in the form of propellant, fuel, or electrical energy. The greater the delta V required for any mission, then the larger and heavier a spacecraft must be to achieve a desired objective due to the extra on-board propellant requirements or thruster sizing. These enhancements work to reduce energy expenditure by spacecraft in achieving delta V adjustments to approach space objects. Advantageously, a larger quantity of target objects can be approached by a spacecraft and the useful life of any spacecraft can be extended. To achieve these enhancements, the delta V required between each object rendezvous or approach is minimized as discussed herein. Thus, a large sequence of any target objects, such as satellites, NEOs, comets, or planetary moons, can be approached by a spacecraft with a minimum expenditure of delta V to measure various characteristics of each target object.

As an explicit example of the utility of this approach, consider the challenge of exploring multiple NEOs within a single mission. The trajectories of thousands of NEOs within a range of, for example, plus or minus 0.1 astronomical units (AU) have been cataloged. Projections of these trajectories can be determined for observation as the NEOs pass within predetermined distances of Earth, or for observation by spacecraft launched from Earth. Thus, for such NEOs, positions with respect to Earth at any given time is known. In order to provide for rendezvous and observation of a plurality of these NEOs by a spacecraft, the spacecraft would employ various changes in directions after each rendezvous to achieve a sequence of approaches with further NEOs. Each change in direction involves the expenditure of energy, related to a delta V factor. Such energy is usually provided by structures and associated propellent on the spacecraft such as rockets, gas jets, or other similar structures. By minimizing the delta V required for each rendezvous or approach, a greater number of maneuvers for rendezvous by any given spacecraft can be achieved during the useful life of the spacecraft.

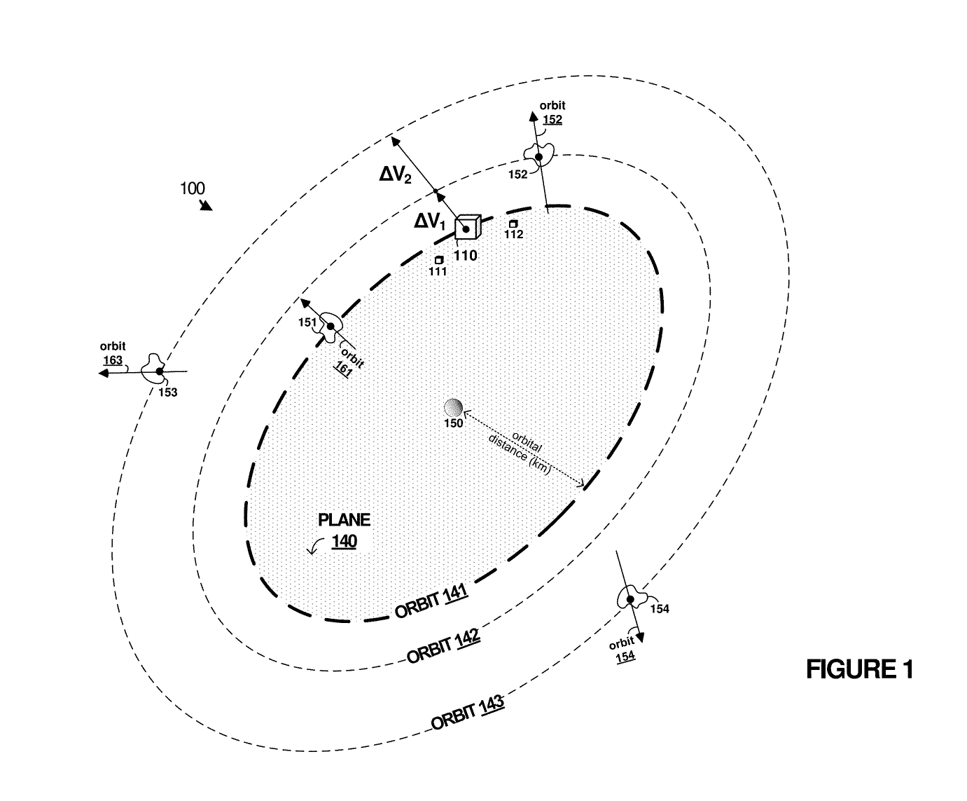

Turning now to a first example implementation of the enhanced techniques discussed herein, FIG. 1 is presented. FIG. 1 illustrates an example space exploration environment 100. Environment 100 includes spacecraft 110 in an orbital configuration about central body 150. Various target objects 151-154 are included as example target objects for approach by spacecraft 110 for performance of one or more objectives, such as measurement of characteristics of the target objects. Although not required, spacecraft 110 might be accompanied by one or more other auxiliary spacecraft 111-112.

In FIG. 1, spacecraft 110 is positioned into an orbital configuration that lies within a selected orbital plane 140. This selected orbital plane extends outward in a two-dimensional manner and any number of orbits can be achieved within this two-dimensional plane. Plane 140 is shown at a particular inclination with respect to central body 150, but it should be understood that any inclination can be selected which can define the particular orbital plane. Maneuvers by the spacecraft rely upon delta V adjustments for approach to NEOs or other target objects, and these delta V adjustments are made within the selected orbital plane.

Approach of the target objects is determined based in part on crossings of the target objects with the selected orbital plane. The target objects, such as objects 151-154 in FIG. 1, might have various corresponding orbits 161-164 which are not within plane 140 but do provide for crossings of plane 140 at unique associated times and spatial coordinates. A nodal crossing is defined by a time and location that a target object intersects the selected orbital plane of spacecraft 110. Each target object can have an orbit independent of spacecraft 110, yet spacecraft 110 can still approach and rendezvous with each target object by determining the nodal crossing of the target objects. Corresponding delta V adjustments are made in FIG. 1 that show spacecraft 110 adjusting an orbit within plane 140 to allow for approach with the individual target objects. For example, orbit 141 might allow for approach of spacecraft 110 to object 151, orbit 142 might allow for approach of spacecraft 110 to object 152, and orbit 142 might allow for approach of spacecraft 110 to objects 153-154.

Further spacecraft can be included with spacecraft 110, such as in a constellation or regatta formation. These further spacecraft can produce similar delta V adjustments along with spacecraft 110, and be employed to detect further characteristics of the target objects. For example, the spacecraft formation might be configured to pass by each target object with the target object within a formation provided by the spacecraft for more efficient imaging of more than one side of the target objects, more effective or robust determination of various physical properties of the target objects, or for redundancy in case of spacecraft component failure.

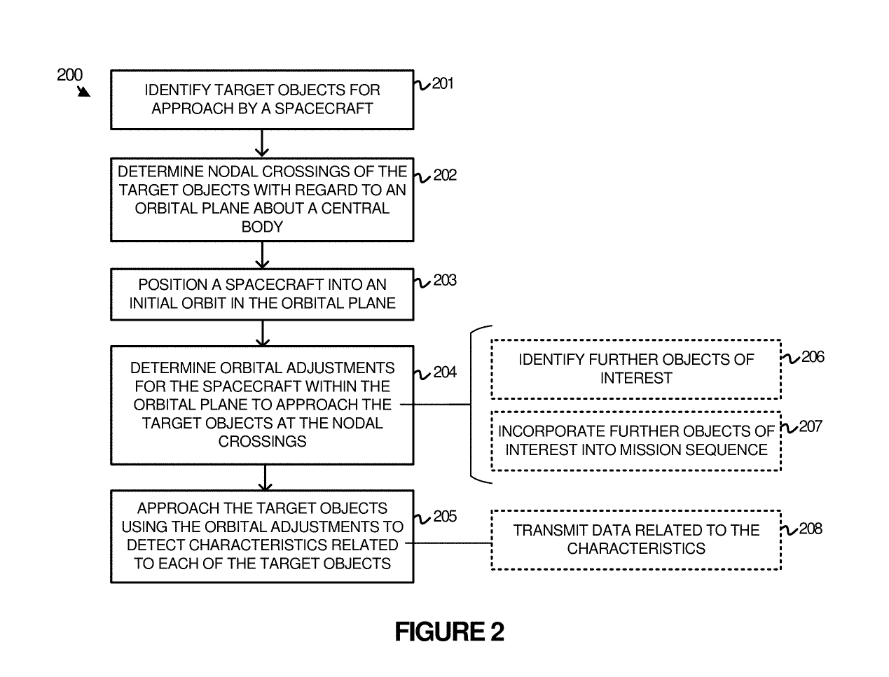

Turning now to an operational method 200 of space exploration, FIG. 2 is presented. The operations of FIG. 2 are related to elements of FIG. 1, although it should be understood that the operational of FIG. 2 can apply to other elements, spacecraft, orbits, and target objects. In FIG. 2, target objects are identified (201) for approach by spacecraft 110. These target objects can be identified from among a large collection of space objects that might include NEOs, asteroids, comets, debris, moons, planetary bodies, spatial anomalies, other spacecraft, or other targets. The target objects can be selected based on any factors, such as commercial/industrial/governmental relevance or interest, suspected physical properties, known physical properties, movement parameters, or other factors. The selection process can occur in situ for an active spacecraft, prior to launch of a spacecraft, or to command operation of an already active spacecraft.

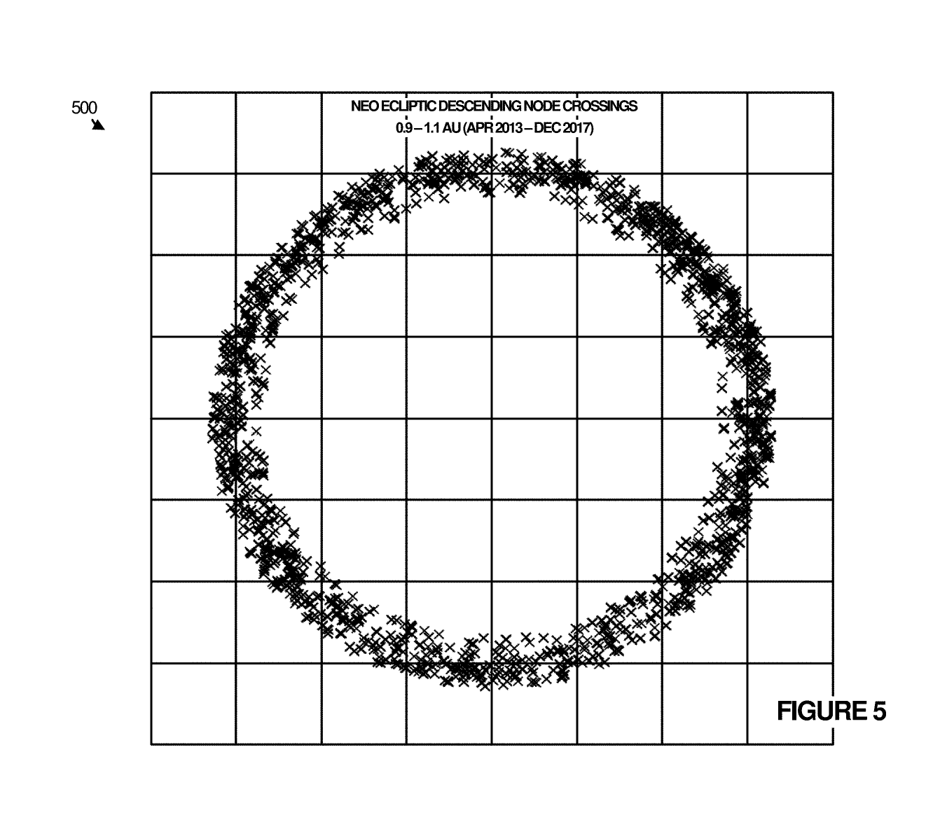

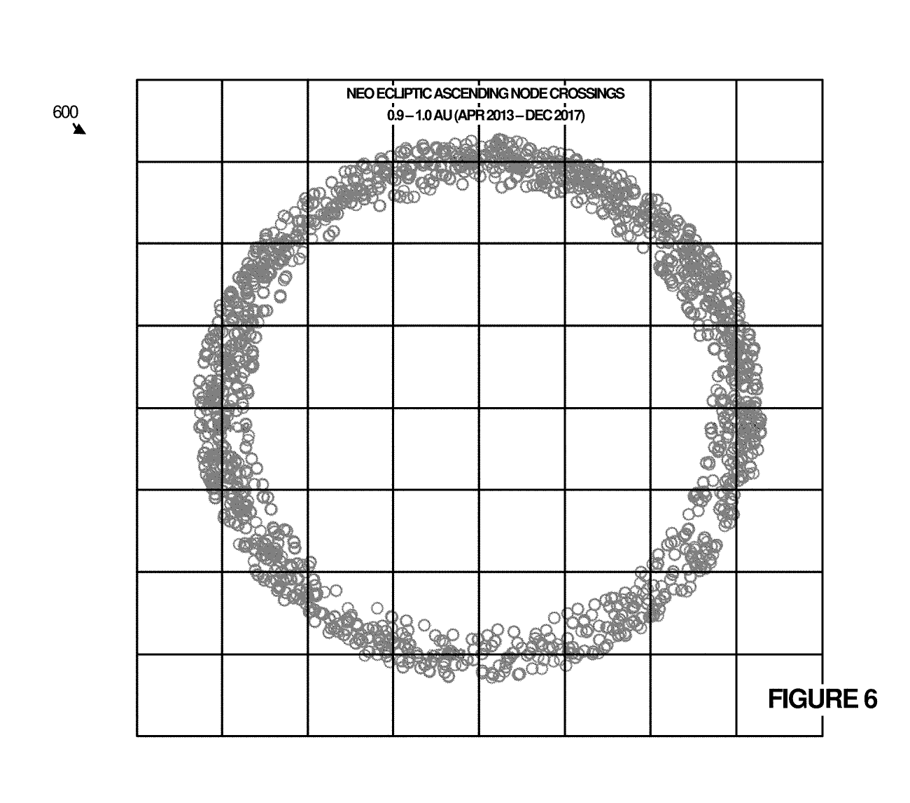

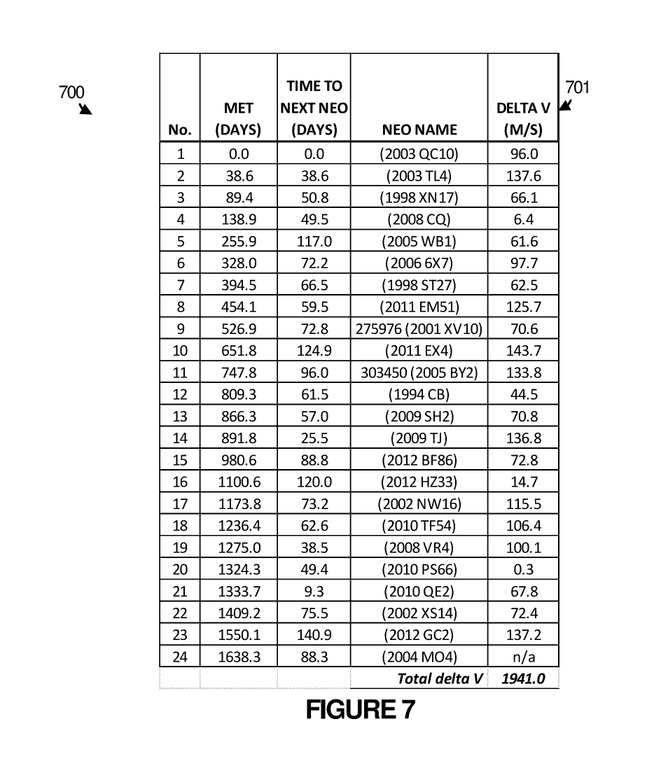

The collection of target objects from which the set of target objects is selected can be comprised of various astronomical databases and search efforts. For example, the NASA NEO program Near-Earth Object Human Space Flight Accessible Targets Study (NHATS) has cataloged trajectories of many NEOs. The nodal crossings of the ecliptic plane by over 7224 NEOs in both ascending and descending modes within plus or minus 0.1 AU of the Earth's orbit within a five-year window has been cataloged. FIG. 5 illustrates example NEO ecliptic plane descending nodal crossings within 0.9 and 1.1 AU in the time period of April 2013 and December 2017. FIG. 6 illustrates example NEO ecliptic plane ascending nodal crossings within 0.9 and 1.1 AU in the time period of April 2013 and December 2017. FIG. 7, discussed below, also shows example NEOs with an example rendezvous sequence. The coordinates shown are in the heliocentric J 2000 reference frame. Similar charts can be provided for other time periods and other inertial space coordinates, as well as for other space bodies and orbital planes.

Once a set of target objects is selected, nodal crossings of the target objects are determined (202) with regard to an orbital plane about a central body. In FIG. 1, this orbital plane can be plane 140 with central body 150. The selected orbital plane for spacecraft 110 can be any arbitrary orbital plane, or might include specific orbital planes such as the ecliptic plane with regard to Earth or a heliocentric plane. The nodal crossings then comprise a time and space parameter indicating when and where each target object crosses the selected orbital plane. Since each target object likely has a corresponding orbital route, each nodal crossing will be unique to each target object with respect to the orbital plane selected for spacecraft 110. Thus, a compilation is created that includes the nodal crossings of the target objects as related to the selected orbital plane of the spacecraft. Since the orbital plane of the spacecraft extends outward from the central body to a potential infinite extent, the nodal crossings might occur at various points in time and space that are distributed across the selected orbital plane.

For example, each target object in FIG. 1 will have a corresponding nodal crossing property with respect to plane 140. Each orbit 151-154 intersects plane 140 at associated orbital crossing points, and each target object actually crosses plane 140 at associated times at the associated orbital crossing points. FIG. 1 shows each target object presently “at” the nodal crossing for illustrative purposes. However, each target object will actually cross through plane 140 at unique times that correspond to the relationship between plane 140, current orbits, and current positions of the target objects. Thus, each nodal crossing will be unique to the target object.

Spacecraft 110 can be positioned (203) into an initial orbit in the orbital plane. This initial orbit can be established by launching spacecraft from an origin, such as from Earth or from a parking orbit around Earth, among other initial locations. Spacecraft 110 can be placed into an initial orbit that lies within orbital plane 140. This orbit can then be adjusted within orbital plane 140 as necessary to approach various target objects. Spacecraft 110 can receive instructions from a control station or control node remote from spacecraft 110. These instructions might comprise positioning instructions, orbital change instructions, orbital plane information and instructions, orbital change sequencing, orientation instructions, approach and measurement instructions, among other information. Spacecraft 110 might receive at least a portion of these instructions via a wireless or optical uplink communication link with an Earth-based, Earth orbit-based, or other control node. Spacecraft 110 might receive a portion of these instructions during manufacture or prior to launch. These instructions can be stored in storage system of spacecraft 110 for execution by one or more processing systems, control systems, circuitry, logistics systems, or other equipment of spacecraft 110.

However, before spacecraft 110 begins to make adjustments for approach to various target objects, one or more orbital adjustments are determined (204) for spacecraft 110 within plane 140 to approach target objects at the nodal crossings. These orbital adjustments can be determined as a sequence or series of delta V adjustments for spacecraft 110. The sequencing of the adjustments can be determined to bring spacecraft 110 within a predetermined distance of each target object when the target objects cross plane 140.

By analyzing the nodal crossing time and inertial space location of each of the nodal crossings for the target objects, a spacecraft mission over a particular duration may be selected to sequentially approach or rendezvous with the target objects using a minimized delta V expenditure. Orbital adjustments within orbital plane 140 can be optimized by selecting an ordering or sequence among the target objects to approach the nodal crossings of the orbital plane of spacecraft 110. By selectively determining a sequence among the nodal encounters, the approaches of spacecraft 110 with each target object may be optimized for approach rate, approach angle, and lighting by the Sun, among other factors.

The sequencing of the nodal crossings provides for a schedule of delta V adjustments that spacecraft 110 should perform in order to approach the target objects at crossings by the target objects of orbital plane 140. As mentioned herein, the delta V adjustments provide for different orbits of spacecraft 110 within orbital plane 140, and thus spacecraft 110 is configured to approach—within a predetermined distance—each of the target objects according to the sequence determined. Thus, the nodal crossings of plane 140 reduces the complexity of maneuvers of spacecraft 110 into a two-dimensional framework. Variations among the sequencing can be determined as well, such as to optimize the sequencing for various factors that include minimizing delta V expenditures over the entire sequence or in between each target object, or to consider conditions of the target objects upon approach. These conditions can include approach parameters, object rotation/orientation, and solar illumination, among other factors.

Once the orbital adjustments for the sequence of approaches has been determined, then spacecraft 110 can be configured to approach (205) the target objects using the orbital adjustments to detect characteristics related to each of the target objects. After approach with a first of the target objects, the orbit of spacecraft 110 in orbital plane 140 is changed so that spacecraft 110 may have an approach with a next target object. Thereafter, the orbit of spacecraft 110 in plane 140 is changed in a selected order to arrive at approaches with each of the target objects in the selected order. The sequence is typically selected to minimize delta V expended by spacecraft 110. However, other factors such as illumination, approach rate, rotation of the target objects, among other factors, can be considered along with delta V expenditure.

Changing of the orbit of spacecraft 110 with delta V adjustments within plane 140 can include changing drift rate, orbital period, or eccentricity of spacecraft 110. However, the orbital changes are made to not significantly affect inclination of spacecraft 110. That is, spacecraft 110 remains in the same orbital plane 140 for the duration of the sequence of delta V adjustments to approach each target object nodal crossing. To further minimize the delta V expended in each orbital change, various orbital transfer techniques such as the Hohmann transfer, the orbits specified in the Interplanetary Transport Network, or other minimum delta V orbital transfers may be utilized. In some examples, an impulsive or finite thrust maneuver can be employed for the delta V adjustments or orbital changes. In yet further examples, a continuous thrust is employed, such as from electromagnetic thrusters, electrostatic thrusters, or other suitable thrusters. Variable or steady thrusts can be employed in the various delta V changes. Since the orbits of spacecraft 110 are maintained in orbital plane 140, the path of spacecraft 110 is essentially in two dimensions. Advantageously, three-dimensional maneuvering is eliminated and prevented by at least determining a sequence of nodal crossings and altering orbital properties of spacecraft 110 using delta V adjustments within plane 140.

During the mission of spacecraft 110, such as after a sequence of target objects has been determined, further objects might be identified (206) as objects of interest. These objects might be identified by detection based on closer proximity of spacecraft 110 or by Earth-based telescope observations, among other considerations. Nodal crossings of plane 140 can be determined for these further objects, and a resequencing of the remaining target objects for approach by spacecraft 110 can be determined. In further examples, prioritization among the remaining target objects and the further objects of interest might be established, such as when one of the further objects of interest might be suspected of having more interest for any particular reason. Spacecraft 110 can incorporate (207) these further objects of interest into the current mission sequence to minimize delta V, which as stated above, might prompt rearrangement of the prior sequence depending on nodal crossings of the further objects of interest.

In some cases, such as where the further objects of interest have a time-sensitive property or quality, a new orbital plane might be determined in order to reach the further objects of interest in a quicker timeframe. Nodal crossings of the remaining target objects can be determined and incorporated into a new sequence of delta V adjustments in response to the new orbital plane. For example, controllers of spacecraft 110 might desire to change from a first heliocentric plane to a second heliocentric plane. This change might occur during the mission profile of spacecraft 110 in order to detect or approach certain NEOs which, even though changing the orbital plane involves expenditure of energy and increased delta V, the particular NEOs to be detected in a different plane may have characteristics to be detected which makes the expenditure of the delta V desirable. This might be the case when the certain NEOs may not cross the current orbital plane within a threshold timeframe, or a trajectory might eject the certain NEOs from a current orbit, among other factors.

Once each of the target objects, including any further objects of interest, have been approached within the predetermined distances, then spacecraft 110 (along with any companion or auxiliary spacecraft) can perform various measurements of the objects. Data representative of these measurements can be transmitted to a destination node, such as communication systems based on Earth or in-orbit about Earth, among other destinations including repeater nodes or other planetary bodies. Data representative of these measurements can be stored on spacecraft 110 for later transmission during favorable conditions for transmit, or to handle variable/low bandwidth or energy requirements of a communication link.

Returning to a discussion of the elements of FIG. 1, target objects 151-154 can comprise any space object. These target objects can include NEOs, asteroids, comets, debris, moons, planetary bodies, spatial anomalies, other spacecraft, or other target objects. Central object 150 typically comprises a body about which spacecraft 110 orbits, such as the Earth, Sun, or any planetary body about which to establish orbits within an orbital plane.

Spacecraft 110, as well as optional auxiliary spacecraft 111-112 each comprise various hardware and software elements included in an orbital or space-compatible package. Spacecraft 110-112 can include sensor equipment, imaging systems, communication equipment, antenna systems, data processing equipment, data storage equipment, and control/logistical management elements. Spacecraft 110-112 each can include propulsion and positioning elements, such as engines, thrusters, inertial control systems, attitude control systems, gyroscopic systems, or other propulsion and powering elements. Spacecraft 110-112 can also include power generation and power storage systems, such as solar power systems, battery systems, on-board nuclear power systems, or other power generation and control systems. Spacecraft 110-112 each include a hardware and software configuration that permits applications to execute on the spacecraft. In some implementations, spacecraft 110-112 may be launched using a launch system with communications, data, instructions, and software provided in an uplink from a ground control system.

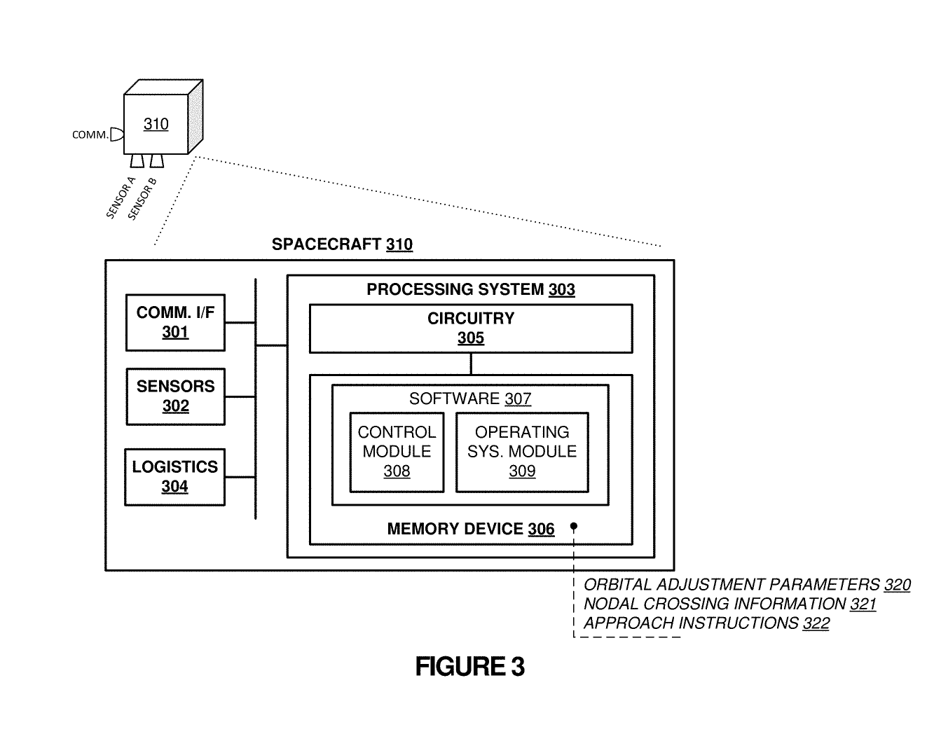

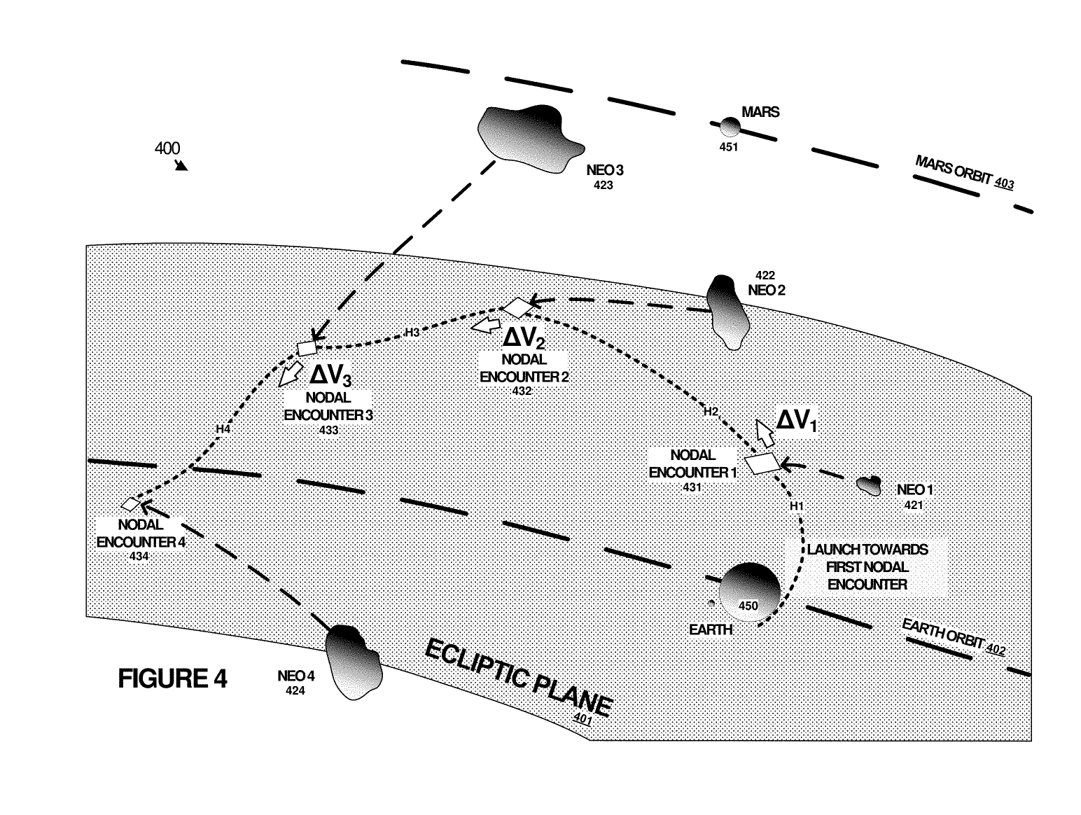

To further illustrate an example of spacecraft 110-112, FIG. 3 is presented. FIG. 3 illustrates an expanded view of spacecraft 310 capable of providing a platform for space exploration according to an implementation. Spacecraft 310 is representative of any spacecraft or satellite system or systems with which the various operational architectures, processes, scenarios, and techniques disclosed herein for a space vessel may be implemented. Spacecraft 310 is an example of a spacecraft from FIG. 1 and FIG. 4, although other examples may exist. Spacecraft 310 comprises communication interface 301, sensors 302, processing system 303, and logistics 304. Processing system 303 is linked to communication interface 301, sensors 302, and logistics 304.

Sensors 302 may comprise detection structures designed to measure at least one characteristic of target objects. Sensors 302 may comprise imaging sensors, heat sensors, light sensors, radar sensors, lidar sensors, or some other type of sensor. Processing system 303 includes processing circuitry 305 and memory device 306 that stores operating software 307 as well as data related to detected characteristics for target objects. Spacecraft 310 may include other well-known components such as batteries, solar panels, antennas or antenna arrays, and enclosures that are not shown for clarity.

Communication interface 301 comprises signal receiving and transmitting structures. Communication interface 301 is configured to transmit information signals that may contain data representing the detected characteristics of the target objects. Communication interface 301 is configured to receive further information signals transmitted to the spacecraft, such as for instructions on when to transmit the detected characteristics/data, commands for sequencing of delta V maneuvers, timing, logistics control, software control, on-board control system management, or other functions. Communication interface 301 comprises components that communicate over communication links, such as network cards, ports, radio frequency (RF), processing circuitry and software, or some other communication devices. Communication interface 301 may be configured to communicate over wireless links Communication interface 301 may be configured to use various multiplexing protocols, wireless protocols, communication signaling protocols, Internet Protocol (IP), or some other communication format, including combinations thereof. In some implementations, communication interface 301 may communicate with one or more other spacecraft in a spacecraft platform and communicate with ground/base control systems.

Processing circuitry 305 comprises microprocessor and other circuitry that retrieves and executes operating software 307 from memory device 306. Memory device 306 may include volatile and nonvolatile, removable and non-removable media implemented in any method or technology for storage of information, such as computer readable instructions, data structures, program modules, or other data. Memory device 306 may be implemented as a single storage device, but may also be implemented across multiple storage devices or sub-systems. Memory device 306 may comprise additional elements, such as a controller to read operating software 307. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

Processing circuitry 305 is typically mounted on circuit boards that may also hold memory device 306 and portions of communication interface 301 and sensors 302. Operating software 307 comprises computer programs, firmware, or some other form of machine-readable program instructions. Operating software 307 includes control module 308 and operating system module 309, although any number of software modules may provide various operations. Operating software 307 may further include utilities, drivers, network interfaces, applications, or some other type of software. When executed by processing circuitry 305, operating software 307 directs processing system 303 to operate spacecraft 310 as described herein.

Spacecraft 310 includes control module 308, which is used as a flight control system for the spacecraft. Control module 308 is responsible for controlling logistical control elements 304 of spacecraft 310. Control module 308, which may operate using distinct processing circuitry on spacecraft 310, may be responsible for power management and flight control of the spacecraft, such as instructing engines or thrusters to execute delta V burns, delta V operations, delta V adjustments, spacecraft orientation/attitude adjustments, or other operations. These operations may include managing the deployment of solar panels on the spacecraft, managing the positioning of the spacecraft with regards to target objects or other space bodies, or any other similar operation.

Memory device 306 includes further data and instructions which can be employed, altered, or executed by processing system 303 and circuitry 305, among other elements. In FIG. 3, these further data and instructions comprise orbital adjustment parameters 320, nodal crossing information 321, and approach instructions 322. Orbital adjustment parameters 320 include commands, timing information, and engine/propulsion control instructions for executing delta V adjustments to place spacecraft 310 into a different orbit than previously. Orbital adjustment parameters 320 can include a set of instructions and timing related to sequential execution of orbital adjustments. Once spacecraft 310 reaches a threshold distance/time from a target object, then approach instructions can be performed. Approach instructions 322 comprise instructions for spacecraft 310 for controlling attitudes/orientations of spacecraft 310 with respect to the target objects, characteristics to measure of target objects (such as which sensor to employ and how to image the target objects), among other activities of spacecraft 310 during a rendezvous or approach. Furthermore, Approach instructions 322 can include data storage and transfer instructions, for when and how spacecraft 310 should maintain or transmit data related to the measurements of target objects. When one or more auxiliary or companion spacecraft are employed, Approach instructions 322 can include instructions on orientation among the companion spacecraft with respect to the target object, communication functions to perform among companion spacecraft, and failure instructions in case of failure of one or more companion spacecraft.

Nodal crossing information 321 can comprise one or more data structures that relates time/location information of target objects to the current orbital plane of spacecraft 310. In some examples, a more generalized indication of target objects orbital parameters can be stored by spacecraft 310, and spacecraft 310 can process these orbital parameters along with a selected orbital plane to determine nodal crossings of each of the target objects. A sequence or schedule of orbital adjustments via delta V maneuvers can also be determined and stored by spacecraft 310.

Returning now to a discussion on the operation of one or more spacecraft, FIG. 4 illustrates a further space exploration environment 400. FIG. 4 illustrates a semi-schematic representation of at least a portion of at mission flight profile of a spacecraft making a sequential rendezvous with four Near Earth Objects (NEOs) 421-424. FIG. 4 illustrates two main planetary bodies, namely Earth 450 having orbit 402 and Mars 451 having orbit 403. FIG. 4 illustrates the operation of a spacecraft in heliocentric ecliptic plane 401, for a trajectory in a mission profile between Earth and Mars. However, any other spatial location on a heliocentric plane may be selected depending upon the nodal crossings of the plane by the NEOs for which it is desired to have characteristics measured.

One or more spacecraft, such as those discussed herein, are launched from Earth for rendezvous with at least four NEOs 421-424, each at a respective nodal crossing of the NEOs with a selected orbital plane of the spacecraft. In this example, ecliptic plane 401 is selected as the orbital plane of the spacecraft, which comprises a heliocentric orbital plane with the Sun as the central body (not shown in FIG. 4 for clarity). In further examples, other selected orbital planes can be employed.

Turning now to the operation of the spacecraft, the launch of the spacecraft from Earth is into a first heliocentric orbit H1 within ecliptic plane 401 to achieve rendezvous with NEO1 421 at nodal encounter 1 (431), where the spacecraft is instructed to pass by NEO1 421 at a preselected distance. When the spacecraft is at the preselected distance, the spacecraft can be configured to take measurements of characteristics of NEO1 421. The spacecraft performs an orbital change to a second heliocentric orbit H2 in ecliptic plane 401 by expenditure of the necessary delta V to direct the spacecraft towards the inertial space position of nodal encounter 2 (432) to arrive at the time of a nodal crossing of NEO2 422 with ecliptic plane 422 to pass within a preselected distance of NEO2 422. When the spacecraft is at the preselected distance, the spacecraft can be configured to take measurements of characteristics of NEO2 422. The spacecraft then expends another delta V as shown at delta V2 to change the orbit of the spacecraft to a third heliocentric orbit H3 in ecliptic plane 401 to direct the spacecraft towards the inertial space position of nodal encounter 3 (433) to arrive at the time of a nodal crossing of NEO3 433 and pass within a preselected distance of NEO3 433. The spacecraft then expends a third delta V as shown at delta V3 to change the spacecraft orbit to a fourth heliocentric orbit H4 in ecliptic plane 401 to direct the spacecraft towards the inertial space position of nodal encounter 4 (434) to arrive at the time of a nodal crossing of NEO4 424 and pass within a preselected distance of NEO4 424.

These measurements of each target object (NEOs 1-4) can include imaging using any suitable portion of the electromagnetic spectrum, chemical detection measurements, composition measurements, altimeter measurements planetary geography measurements, spectrometer measurements, gravitational measurements, rotation measurements, orbital measurements, among others. The spacecraft can transmit information signals comprising the measurements to Earth 450 or other receiving body. Alternatively, the measurements may be stored on the spacecraft for transmit at a later time.

According to the principles of the present disclosure, the nodal crossing of the NEOs can be ascending modes or descending modes with respect to the selected orbital plane. The spacecraft considers the inertial space coordinates and times of the nodal crossing of the plane by each target object. Advantageously, the complexity of a three-dimensional navigational mission is reduced to a two-dimensional complexity. The spacecraft need only travel in two dimensions in a selected orbital plane, such as the heliocentric plane, rather than trying to chase a particular target object in three dimensions to match a target object position or velocity. Any delta V required to provide the mission profile for the spacecraft can also be extended to many more target objects using proper selection of a sequence of approaches to minimize expenditure of delta V to reach each nodal crossing. A mission life of the spacecraft can thus be maximized beyond that of spacecraft that do not employ the techniques herein. Minimizing the delta V required for the mission allows for a much smaller spacecraft carrying smaller amounts of propellant/fuel or compressed gas necessary to achieve the required delta V.

FIG. 7 illustrates an example exploration survey 700 of example of NEOs. Specifically, table 701 shows an example “Grand Tour” of a spacecraft mission in the ecliptic plane to visit 24 separate NEOs in an unoptimized mission profile in a 4-year period for a total delta V expended over the entire mission time of less than 2 km/s. By providing an optimized mission profile, hundreds of NEOs could be cataloged and characterized in the same mission time period of less than five years for about the same total delta V.

Each of the 24 NEOs can be sequentially approached by one or more spacecraft operating within a selected orbital plane. Any delta V adjustments are made to alter orbits of the spacecraft, but the orbits are adjusted to always lie within the selected orbital plane. For example, a particular heliocentric orbital plane that may be selected, such as the Sun-centric ecliptic plane, though any other desired plane may be selected. After selecting the particular heliocentric plane, a group of NEOs is selected for approach and measurement by the spacecraft, and sequencing of approaching each of the nodal crossings is determined. Sequencing of the approaches might be in an unoptimized manner, in which delta V expenditure is not minimized among the sequencing. The sequencing of the approaches might instead be in an optimized manner, in which the delta V expenditure is minimized among the sequencing. Since the trajectories of the NEOs are typically known beforehand, nodal crossings of the NEOs through the selected plane by each of the NEOs can be determined. These nodal crossings are typically fixed in time and in inertial space for orbiting objects, but might change over time for objects such as comets or objects with on-board propulsion. By selectively determining the nodal crossings, a sequence of the approaches by the spacecraft with each NEO may be further optimized for enclosure rate, approach angle, and solar illumination, among other factors.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the disclosure. Those skilled in the art will also appreciate that the features described above can be combined in various ways to form multiple implementations. As a result, the invention is not limited to the specific implementations described above, but only by the claims and their equivalents.

What is claimed is:

1. A method of space exploration, comprising:
identifying target objects for approach by at least a spacecraft;
determining nodal crossings of the target objects with regard to a selected orbital plane about a central body;
positioning the spacecraft into an initial orbit in the selected orbital plane;
determining one or more orbital adjustments for the spacecraft that are restricted to the selected orbital plane to sequentially approach the target objects at the nodal crossings; and
approaching the target objects using the one or more orbital adjustments to detect at least a characteristic related to each of the target objects.

2. The method of claim 1, wherein the nodal crossings comprise a predicted time and position of the target objects at intersection with the selected orbital plane.

3. The method of claim 1, wherein each of the one or more orbital adjustments comprise delta V adjustments that change one or more among a drift rate of the spacecraft, an orbital period of the spacecraft, an eccentricity of the spacecraft, or an orbital distance of the spacecraft.

4. The method of claim 1, wherein at least a portion of the one or more orbital adjustments are selected among Hohmann orbital transfers, Interplanetary Transport Network orbital transfers, variable thrust maneuvers, and continuous thrust maneuvers.

5. The method of claim 1, wherein determining the one or more orbital adjustments for the spacecraft that are restricted to the selected orbital plane comprise changes in orbit of the spacecraft about the central body without substantially changing an inclination of the spacecraft with respect to the central body.

6. The method of claim 1, wherein approaching the target objects comprises approaching the target objects within a predetermined distance to perform one or more objectives with respect to the target objects.

7. The method of claim 6, wherein the one or more objectives include at least one of imaging the target objects and detecting physical properties of the target objects.

8. The method of claim 1, further comprising:
transmitting data related to at least the characteristic related to each of the target objects for receipt by a destination node.

9. The method of claim 1, further comprising:
positioning one or more additional spacecraft into the initial orbit in the selected orbital plane in formation with the spacecraft;
determining one or more further orbital adjustments for the one or more additional spacecraft that are restricted to the selected orbital plane to sequentially approach the target objects at the nodal crossings; and
approaching the target objects using the one or more further orbital adjustments to detect at least the characteristic from more than one orientation with respect to the target objects and in conjunction with the spacecraft.

10. The method of claim 1, wherein the target objects comprise Near-Earth Objects and the selected orbital plane comprises a heliocentric ecliptic plane.

11. A spacecraft exploration apparatus comprising:
one or more computer readable storage media;
a processing system operatively coupled with the one or more computer readable storage media; and
program instructions stored on the one or more computer readable storage media, that when executed by the processing system, direct the processing system to at least:
identify target objects for approach by at least a spacecraft;
determine nodal crossings of the target objects with regard to a selected orbital plane about a central body;
determine one or more orbital adjustments for the spacecraft that are restricted to the selected orbital plane to sequentially approach the target objects at the nodal crossings; and
instruct the spacecraft to approach the target objects within a predetermined distance using the one or more orbital adjustments to detect at least one characteristic related to each of the target objects.

12. The apparatus of claim 11, wherein the nodal crossings comprise a predicted time and position of the target objects at intersection with the selected orbital plane.

13. The apparatus of claim 11, wherein each of the one or more orbital adjustments comprise delta V adjustments that change one or more among a drift rate of the spacecraft, an orbital period of the spacecraft, an eccentricity of the spacecraft, or an orbital distance of the spacecraft; and wherein at least a portion of the one or more orbital adjustments are selected among Hohmann orbital transfers, Interplanetary Transport Network orbital transfers, variable thrust maneuvers, and continuous thrust maneuvers.

14. The apparatus of claim 11, wherein determining the one or more orbital adjustments for the spacecraft that are restricted to the selected orbital plane comprise changes in orbit of the spacecraft about the central body without substantially changing an inclination of the spacecraft with respect to the central body.

15. The apparatus of claim 11, wherein the at least one characteristic comprises physical properties of the target objects.

16. The apparatus of claim 11, comprising further program instructions, that when executed by the processing system, direct the processing system to at least:
instruct the spacecraft to transmit data related to at least the characteristic related to each of the target objects for receipt by a destination node.

17. The apparatus of claim 11, wherein the target objects comprise Near-Earth Objects and the selected orbital plane comprises a heliocentric ecliptic plane.

18. A method of space exploration, comprising:
selecting a first heliocentric plane;
selecting a group of near-earth objects of which a characteristic of each is to be detected;
determining a time each one of the group of selected near-earth objects will pass through the first heliocentric plane;
determining a spatial location of each one of the group of selected near-earth objects will pass through the first heliocentric plane;
positioning a spacecraft into a first preselected orbit in the first heliocentric plane, the first preselected orbit to provide the spacecraft to pass within a first preselected distance of a first of the group of selected near-earth objects at an associated time that the first of the group of selected near-earth objects passes through the first heliocentric plane;
detecting a preselected characteristic of the first of the group of selected near-earth objects responsive to the spacecraft reaching the first preselected distance;
sequentially changing the orbit of the spacecraft in the first heliocentric plane to pass in a preselected order within preselected distances of each of the remainder of the group of selected near-earth objects at corresponding times that each of the remainder of the group of selected near-earth objects pass through the first heliocentric plane; and
detecting one or more characteristics of each of the remainder of the group of selected near-earth objects for responsive to the spacecraft reaching the preselected distance from each of the remainder of the group of selected near-earth objects.

19. The method of claim 18, further comprising:
changing the orbit of the spacecraft by at least employing a Hohmann transfer for orbital changes of the spacecraft to approach at least some of the remainder of the group of selected near-earth objects.

20. The method of claim 18, further comprising:
changing the orbit of the spacecraft by at least employing at least one among Hohmann transfers and Interplanetary Transport Network orbital transfers for orbital changes of the spacecraft to approach at least some of the remainder of the group of selected near-earth objects.
